(19) United States
(12) Patent Application Publication
(10) Pub. No.: US 2010/0161920 A1
(43) Pub. Date: Jun. 24, 2010

(54) DATA MANAGEMENT APPARATUS, DATA MANAGEMENT SYSTEM, AND DATA MANAGEMENT METHOD

(75) Inventor: Kunihiko KASSAI, Kawasaki (JP)

Correspondence Address: STAAS & HALSEY LLP, SUITE 700, 1201 NEW YORK AVENUE, N.W., WASHINGTON, DC, 20005, US

(73) Assignee: Fujitsu Limited, Kawasaki (JP)

(21) Appl. No.: 12/629,356

(22) Filed: Dec. 2, 2009

(30) Foreign Application Priority Data
Dec. 22, 2008 (JP) 2008-325066

(51) Int. Cl. G06F 12/16; G06F 12/00

(52) U.S. Cl. 711/161; 711/170; 711/E12.001; 711/E12.002; 711/E12.103

(57) ABSTRACT

A data management apparatus, system and method are provided. The data management apparatus performing storage processing and readout processing of data for a plurality of storage devices includes a division unit that divides the data into two or more pieces of divided data, a storage destination selection unit that selects, as storage destinations for the pieces of divided data, two or more different storage devices mounted on the data management apparatus, and a distributed storage control unit that stores the pieces of divided data divided by the division unit in the storage destinations selected by the storage destination selection unit in a distributed manner.

### CROSS-REFERENCE TO RELATED APPLICATION(S)

This application is related to and claims priority to Japanese Patent Application No. 2008-325066, filed on Dec. 22, 2008, and incorporated herein by reference.

### FIELD

The embodiments discussed herein are directed to controlling data storage processing and data readout processing for storage devices.

### BACKGROUND

Conventionally, an archive system archives data scattered on a network and centrally manages the data. In the archive system, to prevent tampering with data, data may be stored in accordance with WORM (Write Once Read Many) that inhibits deletion and modification of data. This archive system with the WORM function may be s used for preservation and management of data of medical charts and e-mail, for example.

Conventionally an archive server sets a “read only” access restriction on archival volumes used by application programs.

In this archive system with the WORM function, the archive server receives data from higher-level application servers and operation servers (application programs) and stores the received data in a storage device in the archive server. Once data is written, the application programs are only allowed to read out the data.

In this conventional archive system, a processor (a content management processor) provided in the archive server manages data. However, in the archive server, general storage devices are recognized as disks for use by an OS (Operating System) and are used for data storage.

Therefore, for example, if a malicious manager or third party uses a fraudulently obtained ID or password to access the content management processor, the malicious third party or the like may be able to access data in a disk mounted on the content management processor and modify or delete the data.

### SUMMARY

It is an aspect of the embodiments discussed herein to provide a data management apparatus, system, and method.

The above aspects can be attained by a system a data management apparatus performing storage processing and readout processing of data for a plurality of storage devices includes a division unit that divides the data into two or more pieces of divided data, a storage destination selection unit that selects, as storage destinations for the pieces of divided data, two or more different storage devices mounted on the data management apparatus, and a distributed storage control unit that stores the pieces of divided data divided by the division unit in the storage destinations selected by the storage destination selection unit in a distributed manner.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

These together with other aspects and advantages which will be subsequently apparent, reside in the details of construction and operation as more fully hereinafter described and claimed, reference being had to the accompanying drawings forming a part hereof, wherein like numerals refer to like parts throughout.

### BRIEF DESCRIPTION OF DRAWINGS

FIG. 1 illustrates a configuration of an archive apparatus;

FIG. 2 illustrates an ID information management table;

FIG. 3 illustrates a mounting state management table;

FIG. 4 illustrates a readout queue table;

FIG. 5 illustrates processing where content data in the archive apparatus is not accessed;

FIG. 6 illustrates processing where an access occurs to content data in the archive apparatus;

FIG. 7 illustrates redistribution processing for content data in the archive apparatus; and

FIGS. 8A-8C illustrate processing content data in the archive apparatus.

### DETAILED DESCRIPTION OF EMBODIMENTS

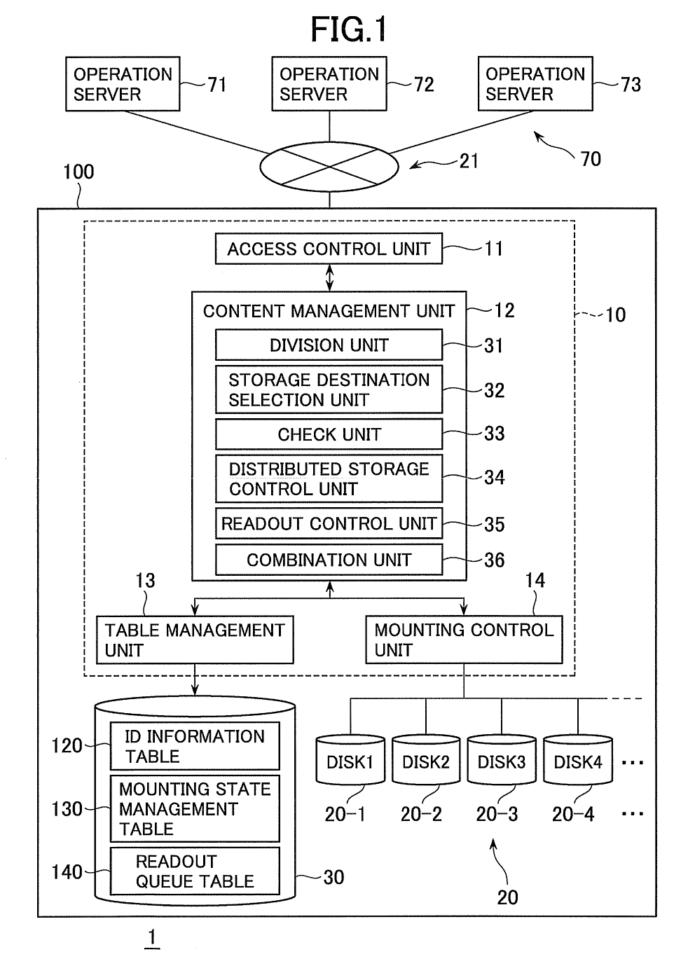

FIG. 1 illustrates an exemplary configuration of a storage system having an archive apparatus. As illustrated in FIG. 1, the storage system 1 (e.g., a data management system) includes one or more operation servers 70, e.g., operation servers 71, 22, and 73, a communication line 21, and the archive apparatus 100 (e.g., a data management apparatus).

As illustrated in FIG. 1, the archive apparatus 100 includes a content management processor 10, a table storage unit 30, and a plurality of storage devices 20 including for example, storage devices 20-1, 20-2, 20-3, 20-4, etc.

The storage devices 20-1, 20-2, 20-3, 20-4, etc. may be HDDs (Hard Disk Drives) or SSDs (Solid State Drives), for example. Each storage device may be communicatively connected to the archive apparatus 100 via an interface that is not shown.

Each of the storage devices 20-1, 20-2, 20-3, 20-4, etc., may substantially be similar in configuration. The reference character “20” followed by “- (hyphen)” and a number will be used to refer to one of the storage devices, while the reference character “20” will be used when referring to any of the storage devices.

The storage devices 20-1, 20-2, 20-3, 20-4, etc., may also include a respective “DISK1, DISK2, DISK3, DISK4, . . . etc., as illustrated in FIG. 1

Further, as illustrated in FIG. 1, the archive apparatus 100 (e.g., the data management apparatus may be communicatively connected with a plurality of operation servers 70 including, for example, operation servers 71, 72, and 73 via the communication line 21.

Standards that can be used for the communication line 21 include FC (Fibre Channel), SCSI (Small Computer System Interface), LAN (Local Area Network), and the like. Standards for the communication line 21 are not limited to these FC, SCSI, LAN, and the like, but may be implemented with various modifications.

The operation servers 71, 72, and 73 may be information processing apparatuses capable of executing various programs. For example, the operation servers execute a program that handles medical data and a program that handles e-mail data.

Data generated in the operation servers 71, 72, and 73 may be transmitted via the communication line 21 to the archive apparatus 100, where the data is stored in the storage devices 20. By way of example, the data may include medical data, e-mail data, and content data.

Hereinafter, as reference characters for indicating the individual operation servers, the reference characters “71,” “72,” and “73” will be used when referring to one of the operation servers, while the reference character “70” will be used when referring to any of the operation servers.

While FIG. 1 illustrates the example in which three operation servers 71, 72, and 73 are provided in the storage system 1, however, other numbers may be used. That is, fewer or more than three operation servers may be provided and each connected to the archive apparatus 100.

The archive apparatus 100 may be a RAID (Redundant Arrays of Inexpensive Disks) apparatus, for example. In response to a readout request from an operation server 70, the archive apparatus 100 reads out data (content data) from storage devices 20 and provides the data to the operation server 70. Similarly, in response to a write request from an operation server 70, the archive apparatus 100 writes (stores), into the storage devices in the storage 20, content data transmitted along with the write request.

The archive apparatus 100 may be configured as a WORM (Write Once Read Many) structure in which content data once written to the storage devices 20 is not modified. That is, from the operation servers 70, which are higher-level apparatuses, data once written is only allowed to be read out. Thus, original data stored in the storage devices 20 is protected against data tampering/deletion caused by operational mistakes or performed by intention.

In the archive apparatus 100, for example, an access control unit 11 may assign a content ID (identification) to each piece of stored content data in order to uniquely manage the content data. That is, for example, if content data stored (archived) with the ID=1 is updated by an application of an operation server 70 and archived again, the access control unit 11 assigns a different ID (=2) to the content data as new content data instead of overwriting the content data with the ID=1.

The table storage unit 30 stores an ID information management table 120, a mounting state management table 130, and a readout queue table 140, and it is a storage device such as an HDD or SSD, for example. The storage device for implementing the function as the table storage unit 30 may be provided separately from the above-described storage devices 20.

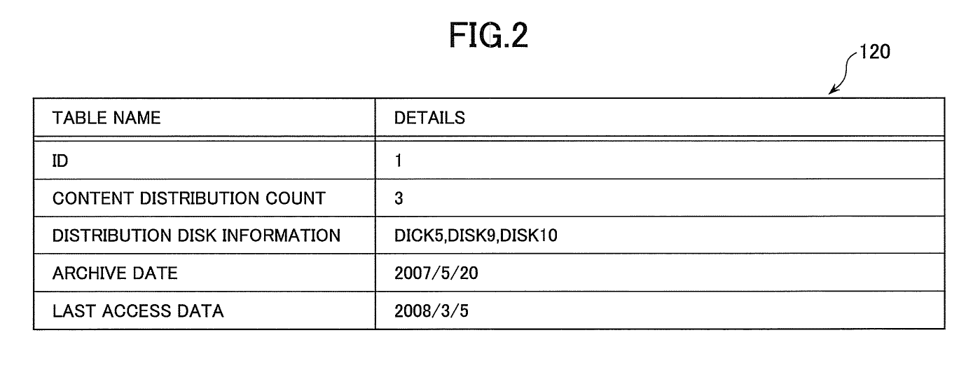

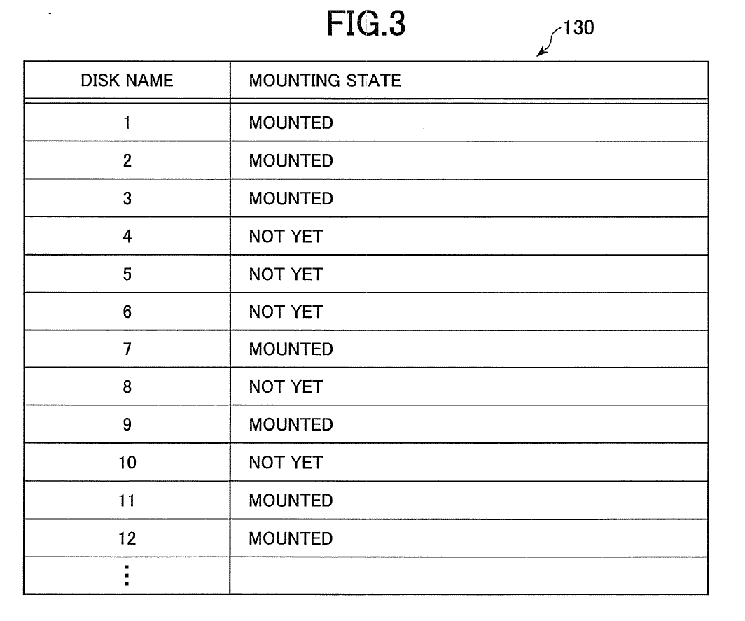

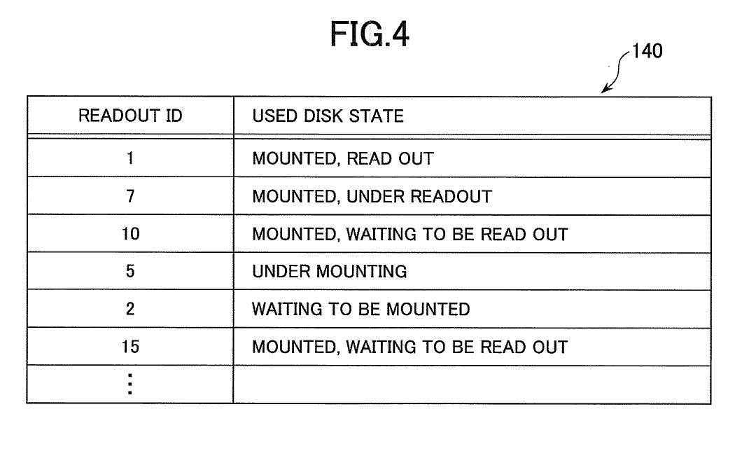

FIG. 2 illustrates the ID information management table 120, FIG. 3 illustrates the mounting state management table 130, and FIG. 4 illustrates the readout queue table 140.

The mounting state management table 130 represents mounting states on the archive apparatus 100 for the storage devices 20 provided in the archive apparatus 100. In the example illustrated in FIG. 3, the mounting state management table 130 may be configured by associating the items “DISK name” and the items “mounting state.”

“Mounting” may be defined as causing a storage device 20 to be recognized and bringing the storage device 20 into an operable state. Mounting a storage device 20 on the archive apparatus 100 enables the archive apparatus 100 to access information stored in the storage device 20. This mounting operation is implemented by a function of the OS, for example.

The items “DISK name” are information that may be used for identifying the individual storage devices in the storage 20. While any information such as combinations of alphanumeric characters may be used as the DISK names, FIG. 3 illustrates the example in which numbers are used. In this embodiment, the numbers used as the DISK names are used as the above-described identification values, for example, based on an individual storage device number. That is, in the example illustrated in FIG. 3, the more than twelve DISK names 1, 2, 3, . . . 12 . . . , etc. correspond respectively to the more than twelve storage devices 20 are provided, like storage devices 20-1, 20-2, 20-3, 20-4, 20-5, 20-6, 20-7, 20-8, 20-9, 20-10, 20-11, 20-12, etc.

The items “mounting state” include are information indicating the mounting state of each storage device 20. In the example illustrated in FIG. 3, the terms “mounted” or “not yet” are registered as a e mounting state. That is, if an storage device 20 is mounted on the archive apparatus 100, the term “mounted” is registered, and if not mounted (unmounted) on the archive apparatus 100, the term “not yet” is registered, in association with the identification value of that storage device 20.

The mounting state management table 130 may be updated and managed by a table management unit 13 based on a control result of a mounting control unit 14 to be described later.

The ID information management table 120 includes information about content data and may be configured by associating an ID, a content distribution count, distribution disk information, an archive date, and a last access date with each other, as illustrated in FIG. 2.

In the archive apparatus 100, a division unit 31 in the content management processor 10 divides content data into two or more pieces of divided data (details will be described later). Information about the divided data of the content data divided in this manner is registered and managed in the ID information management table 120.

The ID is identification information for identifying content data, and it is information uniquely set by the access control unit 11 for identifying the content data. For example, a combination of alphanumeric characters or the like may be used as the ID, and FIG. 4 illustrates an example in which integers are used, like “1, 7, 10, 5, 2, 15, etc.”

The content distribution count is information indicating the number into which the content data has been divided, that is, the number of pieces of divided data generated from the content data.

In the example illustrated in FIG. 2, “3 (the content distribution count=3)” is registered as the content distribution count. This indicates that the content data with the ID=1 has been divided into three pieces of divided data.

The distribution disk information is information indicating in which of the storage devices 20 the divided data of the content data is stored. FIG. 2 illustrates combinations of the character string “DISK” and an identification value to indicate any of the storage devices 20. That is, the example indicates that the three pieces of divided data generated from the content data with the ID=1 are stored respectively in three storage devices , for example, storage devices 205, 209, and 210 represented as the DISK5, DISK9, and DISK10.

The item “archive date” is information indicating the date at which the content data was stored in the archive apparatus 100 (in the individual storage devices in the storage 20). The item “last access date” is information indicating the date at which the content data was accessed last.

The readout queue table 140 indicates mounting states of storage devices 20 in which content data waiting to be read out (waiting to be read) from the individual storage devices in the archive apparatus 100 is stored.

Thereadout queue table 140 may be may be configured by associating the items “readout ID” and the items “used disk state.”

The items “readout ID” are IDs indicating content data waiting be read out (waiting to be read) from individual storage devices in the archive apparatus 100 according to readout requests issued from operation servers 70.

The example illustrated in FIG. 4 indicates that the readout requests for the content data were issued in the order from the top to the bottom of the readout queue table 140 as shown.

The items “used disk state” are information indicating the state of individual storage devices in which divided data of content data corresponding to each ID is stored, and the reading status of the divided data. In the example illustrated in FIG. 4, characters “mounted,” “under mounting,” “waiting to be mounted,” “read out,” “under readout,” and “waiting to be read out” are appropriately combined and stored as the used disk states.

The terms “mounted,” “under mounting,” and “waiting to be mounted” may be defined as information indicating the mounting state of individual storage devices in which divided data of content data corresponding to each ID is stored. If the mounting states vary among the individual storage devices in which the divided data of the content data corresponding to the ID is stored, it may be desirable that a mounting state of the latest status be preferentially registered. That is, “under mounting” is a status later than “mounted,” and “waiting to be mounted” is a status later than “under mounting.”

The terms “read out,” “under readout,” and “waiting to be read out” may be defined as information indicating the readout state of divided data of content data corresponding to each ID. If the readout states vary among the pieces of divided data of the content data corresponding to the ID, it is desirable that a readout state of the latest status be preferentially registered. That is, “under readout” is a status later than “read out,” and “waiting to be read out” is a status later than “under readout”.

The content management processor 10 controls storage and readout of content data in and from the storage devices 20, and may be an information processing apparatus with a server function, for example. A CPU (Central Processing Unit) (not shown) of this information processing apparatus executes a data management program to cause the information processing apparatus to function as the access control unit 11, a content management unit 12 (the division unit 31, a storage destination selection unit 32, a check unit 33, a distributed storage control unit 34, a readout control unit 35, and a combination unit 36), the table management unit 13, and the mounting control unit 14.

A program (the data management program) for implementing functions as the access control unit 11, the content management unit 12 (the division unit 31, the storage destination selection unit 32, the check unit 33, the distributed storage control unit 34, the readout control unit 35, and the combination unit 36), the table management unit 13, and the mounting control unit 14 may be supplied in a form recorded on a computer-readable recording medium, for example a flexible disk, CD (such as CD-ROM, CD-R, or CD-RW), DVD (such as DVD-ROM, DVD-RAM, DVD-R, DVD+R, DVD-RW, DVD+RW, or HD DVD), Blu-ray Disc, magnetic disk, optical disk, magneto-optical disk, or the like. A computer uses the program by reading out the program from the recording medium, transferring the program to an internal storage device or an external storage device, and storing the program therein. The program may also be recorded on a storage device (a recording medium), for example a magnetic disk, optical disk, magneto-optical disk, or the like, and provided to the computer from the storage medium via a communication path.

When the functions as the access control unit 11, the content management unit 12 (the division unit 31, the storage destination selection unit 32, the check unit 33, the distributed storage control unit 34, the readout control unit 35, and the combination unit 36), the table management unit 13, and the mounting control unit 14 are implemented, the program stored in the internal storage device (in this embodiment, RAM or ROM that is not shown) is executed by a microprocessor (in this embodiment, the CPU) of the computer. At this point, the computer may read out and execute the program recorded on a recording medium.

The computer may include hardware and an operating system, and the computer may include the hardware that operates under the control of the operating system. In a case where the operating system is not needed and application programs alone operate the hardware, the hardware itself may correspond to the computer. The hardware includes at least a microprocessor such as a CPU, and is capable of reading computer programs recorded on recording media. According to an exemplary s embodiment, the content management processor 10 serves as the computer.

The content management processor 10 may be communicatively connected with the storage devices 20 via an interface(not shown). This interface may be configured based on a standard such as FC, Serial ATA (SATA (Serial Advanced Technology Attachment)), SAS (Serial Attached SCSI) or the like. The standard for the interface is not limited to these FC, SATA, SAS, or the like, but may be implemented with various modifications.

The access control unit 11 controls accesses from the operation servers 2, which are the higher-level apparatuses, in the content management processor 10. According to a readout instruction (command) received from an operation server 70, the access control unit 11 obtains, from storage devices 20 through the content management unit 12, content data for which the readout request has been issued. The access control unit 11 also assigns an ID for identification to the content data for which the readout request has been issued.

The access control unit 11 then transmits the obtained content data to the operation server 70 via the communication line 21.

The table management unit 13 manages the above-described ID information management table 120, mounting state management table 130, and readout queue table 140. The table management unit 13 reads out certain information from each table to send the information to the content management unit 12, and updates each table.

The table management unit 13 also updates the ID information management table 120, the mounting state management table 130, and the readout queue table 140 based on information (such as control results) from the content management unit 12 and the mounting control unit 14.

The mounting control unit 14 controls mounting of the storage devices 20 on the archive apparatus 100, so that the mounting control unit 14 mounts the storage devices 20 on the archive apparatus 100 under instructions from the content management unit 12 and the like. Mounting as used herein refers to causing a storage device 20 to be recognized by the content management processor 10, thereby making data (divided data) stored in the storage device 20 accessible.

The mounting control unit 14 implements the mounting processing by instructing a disk driver (a device driver) to recognize a storage device in question and mounting the recognized storage device at a mount point. This mounting processing can be implemented with various OSs and device drivers, and will not be described in detail.

The mounting control unit (unmounting control unit) 14 also controls to unmount a storage device 20 mounted on the archive apparatus 100. Unmounting as used herein refers to causing a storage device 20 to be unrecognizable by the content management processor 10, thereby making data (divided data) stored in the storage device 20 inaccessible. Even in this unmounted state, the physical connection (the connected state via the interface) between the content management processor 10 and the storage device 20 is maintained.

In this embodiment, the mounting control unit 14 keeps a storage device 20 unmounted from the content management processor 10 during a no access state in which the storage device 20 is not accessed from the content management processor 10.

That is, in the archive apparatus 100, only if a request involving an access from an operation server 70 or the like to content data is issued, relevant storage devices 20 are mounted.

The determination of the no access state may be made by, for example, recognizing that the ID of content data corresponding to a storage device in question is not registered in the readout queue table 140. The determination may be made with various modifications without departing from the spirit of this embodiment.

The control result of mounting/unmounting of the storage devices 20 performed by the mounting control unit 14 is sent to the table management unit 13. The table management unit 13 updates the mounting state management table 130 and the readout queue table 140.

The content management unit 12 manages processing for storing content data in storage devices 20 and processing for reading out content data stored in storage devices 20.

As illustrated in FIG. 1, the content management unit 12 may serve as the division unit 31, the storage destination selection unit 32, the check unit 33, the distributed storage control unit 34, the readout control unit 35, and the combination unit 36.

The division unit 31 divides content data into two or more pieces of divided data. The division unit 31 logically divides the content data at a level visible by the OS. Each piece of the divided data generated by the division unit 31 does not, by itself, allow the content of the content data to be known even partially.

The number of pieces of divided data generated from the content data (a content data distribution count) may be determined as appropriate. For example, the data size of the divided data (a divided data basic size) may be predefined, and the content data distribution count may be determined by obtaining the number of pieces of divided data in the divided data basic size that can be generated from the content data. The content data distribution count may also be fixedly determined irrespective of the size of the content data.

In this manner, the content data distribution count may be implemented with various modifications without departing from the spirit of this embodiment.

In addition, the dividing of the content data by the division unit 31 may employ various existing ways and will not be described in detail.

Information (the ID of the content data, the division count, etc.) about the divided data generated by the division unit 31 is sent to the table management unit 13. The table management unit 13 updates the ID information management table 120 based on this information.

In the archive apparatus 100, the pieces of divided data generated by the division unit 31 dividing the single piece of content data are stored in different storage devices 20, respectively.

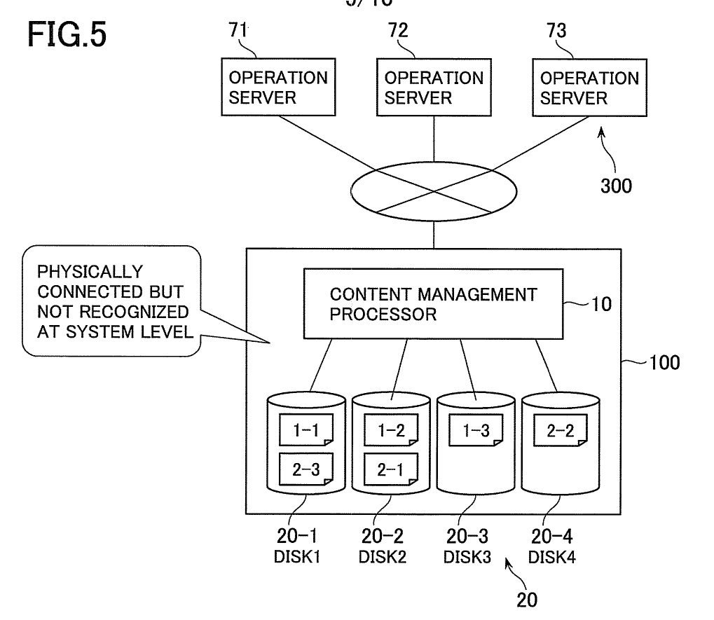

FIG. 5 illustrates processing where content data in the archive apparatus is not accessed.

In the example illustrated in FIG. 5, divided data generated by dividing content data with the ID=1 into three pieces is indicated as the symbols 1-1, 1-2, and 1-3. Similarly, divided data generated by dividing content data with the ID=2 into three pieces is indicated as the symbols 2-1, 2-2, and 2-3.

The divided data 1-1 and 2-3 may be stored in the storage device 20-1 (DISK1), and the divided data 1-2 and 2-1 may be stored in the storage device 20-2 (DISK2). The divided data 1-3 is stored in the storage device 20-3 (DISK3), and the divided data 2-2 is stored in the storage device 20-4 (DISK4).

In the state illustrated in FIG. 5, during the no access state in which the content data is not accessed, each storage device is kept unmounted from the content management processor 10 under the control of the mounting control unit 14. That is, each storage device is physically connected to the content management processor 10 but is not recognized by the content management processor 10 at the system level.

According to a readout request from an operation server 70, the readout control unit 35 obtains (reads out) divided data of content data corresponding to the readout request, from storage devices 20 in which the divided data is stored.

When the readout control unit 35 receives a readout request for content data from the access control unit 11, the readout control unit 35 refers to the ID information management table 120 based on the ID of the content data and obtains storage devices 20 (the distribution disk information) that are storage destinations for pieces of divided data of the content data, respectively. The readout control unit 35 reads out the pieces of divided data from the storage-destination storage devices 20, respectively, and passes them to the combination unit 36.

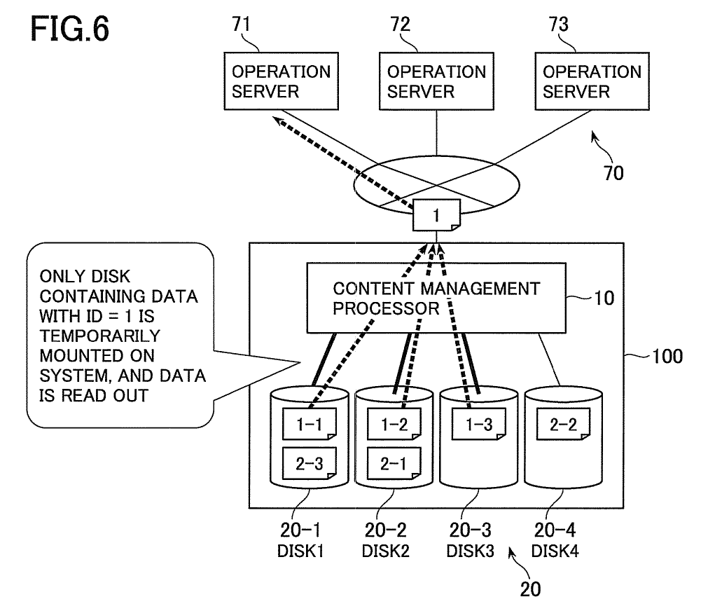

FIG. 6 illustrates processing where an access occurs to content data in the archive apparatus.

As illustrated in FIG. 6, for example, if a read request for the content data with the ID=1 is issued from the operation server 70, the content management unit 12 refers to the ID information management table 120 to check the storage locations (DISK1, DISK2, and DISK3) of the divided data 1-1, 1-2, and 1-3 of the content data with the ID=1.

Then, the mounting control unit 14 mounts the storage devices DISK1 to DISK3 storing the divided data 1-1, 1-2, and 1-3, and the readout control unit 35 reads out the divided data 1-1, 1-2, and 1-3.

The combination unit 36 combines the divided data obtained by the readout control unit 35 and thereby generates the content data. The way of combining the divided data by the combination unit 36 corresponds to the way of dividing the content data by the division unit 31. Therefore, again, the combining of the divided data may employ various existing ways and will not be described in detail.

The content data combined by the combination unit 36 is provided by the access control unit 11 to the operation server 70. Thus, the readout processing is completed.

In the example illustrated in FIG. 6, the divided data 1-1, 1-2, and 1-3 read out by the readout control unit 35 is combined by the combination unit 36 into the single piece of content data, which is then transmitted by the access control unit 11 to the operation server 70a.

Then, in the archive apparatus 100, the content data having undergone this readout processing is stored again in a distributed manner (redistribution processing) in two or more different storage devices 20 mounted on the archive apparatus 100, that is, a different storage device 20 for each piece of divided data.

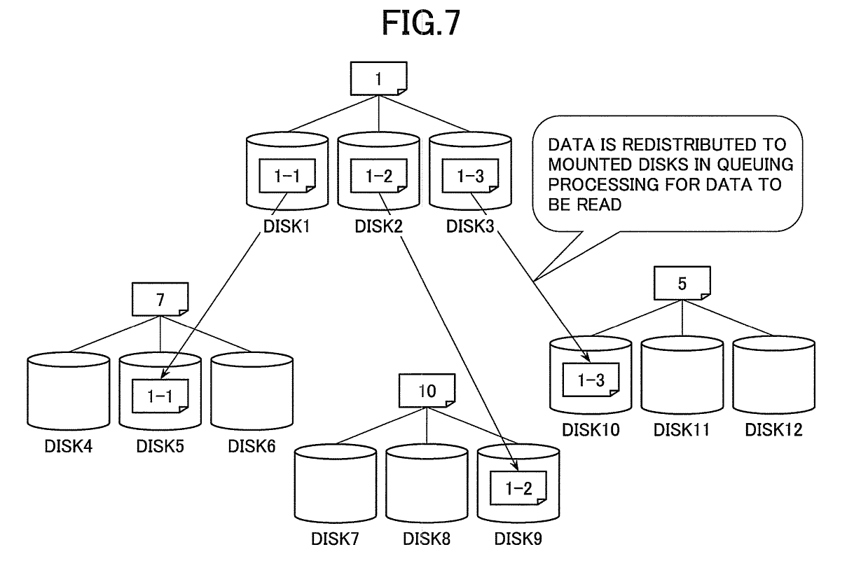

FIG. 7 illustrates the redistribution processing for content data in the archive apparatus.

In the example illustrated in FIG. 7, the content data with the ID=1 is stored in a distributed manner as the divided data 1-1, 1-2, and 1-3 in the DISK1, DISK2, and DISK3. Similarly, content data with the ID=5 is stored in a distributed manner in the DISK10, DISK11, and DISK12, and content data with the ID=7 is stored in a distributed manner in the DISK4, DISK5, and DISK6. Content data with the ID=10 is stored in a distributed manner in the DISK7, DISK8, and DISK9.

In this state, to redistribute the content data with the ID=1, the divided data 1-1, 1-2, and 1-3 of the content data (ID=1) is stored in a distributed manner in storage devices 20 different from the DISK1, DISK2, and DISK3 in which the divided data was stored before the data access.

That is, FIG. 7 illustrates the example in which the divided data 1-1 is redistributed to the DISK5, the divided data 1-2 is redistributed to the DISK9, and the divided data 1-3 is redistributed to the DISK10.

The storage destination selection unit 32 selects storage destinations for the divided data generated by the division unit 31. The storage destination selection unit 32 selects, as the storage destinations for the divided data, two or more different storage devices 20 mounted on the archive apparatus 100.

At this point, the storage destination selection unit 32 does not select overlapping storage devices 20 for storing a plurality of pieces of divided data generated from the single piece of content data.

That is, the storage destination selection unit 32 selects, as the storage-destination storage devices 20 for the divided data, the same number of storage devices 20 as the number of pieces of divided data.

In determining the storage destinations for the divided data, the storage destination selection unit 32 refers to the readout queue table 140 to check whether any content data is waiting to be read. If no content data is waiting to be read, the storage destination selection unit 32 preferentially selects, as the storage-destination storage devices, storage devices 20 currently mounted on the archive apparatus 100.

In this manner, the storage devices 20 already mounted on the archive apparatus 100 are selected as the storage-destination storage devices. This eliminates the need to newly mount other storage devices and allows the data to be stored in a short time.

If any content data is waiting to be read, the storage destination selection unit 32 refers to the readout queue table 140 and the ID information management table 120 to preferentially select, as the storage destinations for the divided data, storage devices 20 storing divided data of the content data waiting to be read.

Further, in this selection of the storage-destination storage devices for the divided data, the storage destination selection unit 32 preferentially selects, as the storage destinations for the divided data, storage devices 20 already mounted on the archive apparatus 100. This eliminates the waiting time for newly mounting storage devices on the archive apparatus 100 and allows the processing of storing the divided data to be performed in a short time.

In selecting the storage-destination storage devices for the divided data, the storage destination selection unit 32 selects, as the storage destinations, storage devices different from the storage devices in which the divided data was stored last time.

In selecting the storage-destination storage devices for the divided data, if storage devices 20 already mounted on the archive apparatus 100 cannot be selected as the storage destinations for the divided data, the storage destination selection unit 32 selects other unmounted storage devices 20 as the storage destinations. These storage devices 20 selected as the storage destinations by the storage destination selection unit 32 in this manner are newly mounted on the archive apparatus 100 by the mounting control unit 14.

The check unit 33 checks that the storage devices 20 are capable of storing the divided data. The check unit 33 obtains the data size of the divided data and checks whether the available space in the storage devices 20 as the storage destination candidates is larger than the data size of the divided data to be stored. The data size of the divided data can be easily obtained by, for example, a function of the OS, and details thereof will not be described.

The distributed storage control unit 34 stores the pieces of divided data divided by the division unit 31 in the storage-destination storage devices 20 selected by the storage destination selection unit 32 in a distributed manner. For example, the distributed storage control unit 34 can store the divided data in the storage devices 20 by using a write command.

The distributed storage control unit 34 stores the divided data in the storage devices 20 confirmed by the check unit 33 as being capable of storing the divided data.

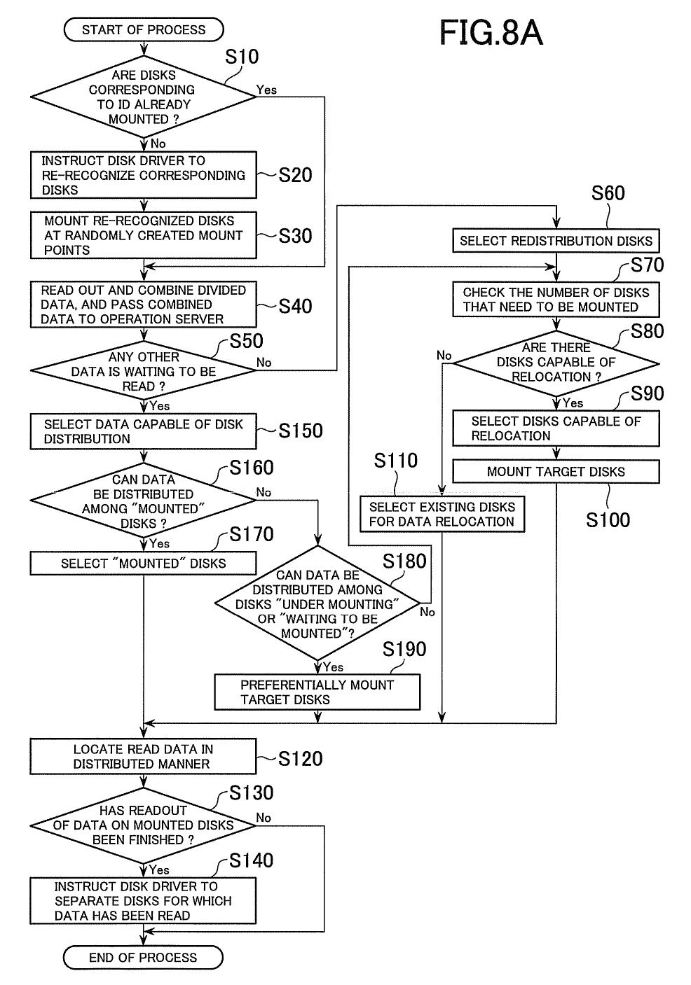

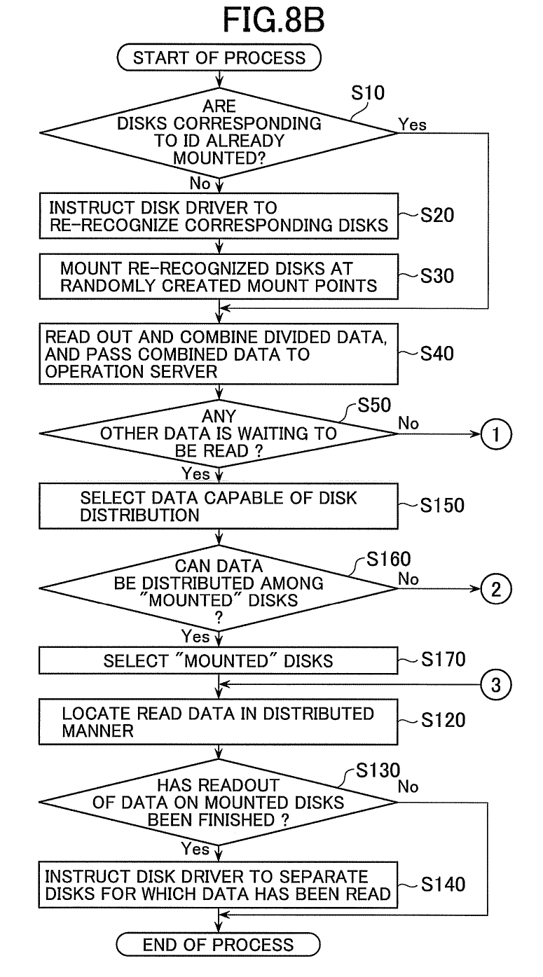

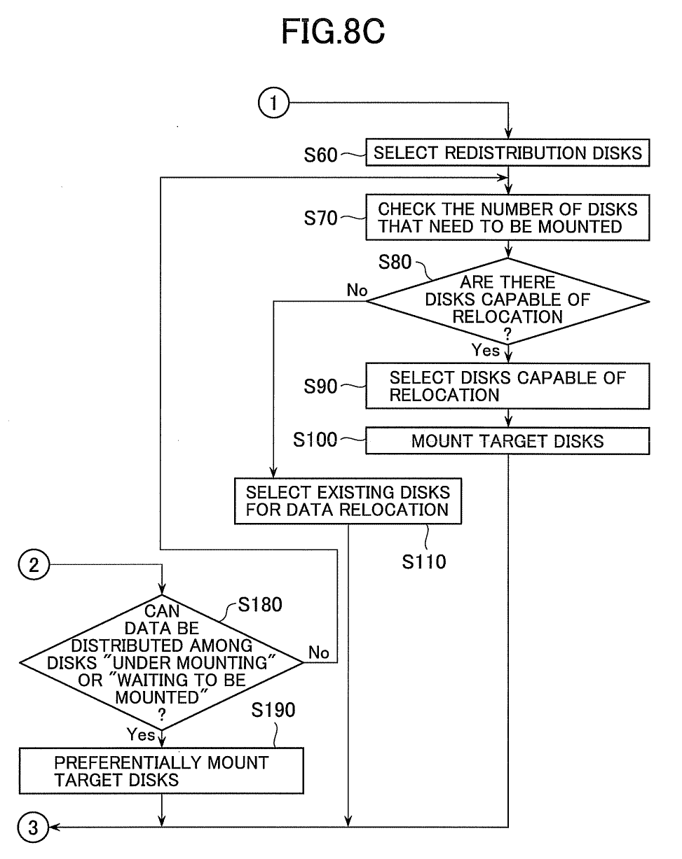

A method of processing content data in the archive apparatus (operations S10 to S190) is illustrated in FIGS. 8A- 8C. The example illustrated in FIGS. 8A-8C represents a case where HDDs are used as the storage devices 20, and the storage devices 20 are simply expressed as disks.

When a readout request for content data is issued from an operation server 70, the access control unit 11 in the archive apparatus 100 obtains the ID of the content data and instructs the content management unit 12 to read out the content data.

The content management unit 12 refers to the ID information management table 120 based on the ID of the content data (reading data) to be read out and obtains storage destinations for divided data of the content data (the distribution disk information).

Based on the storage-destination storage devices, the content management unit 12 refers to the mounting state management table 130 to check whether the storage devices (the storage devices corresponding to the ID) storing the divided data of the content data to be read out are already mounted (operation S10).

If the storage devices storing the divided data of the content data to be read out are not mounted (NO in operation S10), the mounting control unit 14 instructs the disk driver to re-recognize these storage devices (operation S20).

The mounting control unit 14 mounts the re-recognized storage devices at randomly created mount points (operation S30). The result of this mounting processing is reflected by the table management unit 13 in the mounting state management table 130.

The readout control unit 35 reads out the divided data from the mounted storage devices, and the combination unit 36 combines the divided data. Thus, the content data instructed to be read out is generated. The access control unit 11 transmits the generated content data to the operation server 70 that has requested the readout of the content data (operation S40).

If the storage devices storing the divided data of the content data to be read out are already mounted (YES in operation S10), the process transitions to operation S40.

Thereafter, the content management unit 12 refers to the readout queue table 140 to check whether any other content data is waiting to be read (operation S50).

If no other content data is waiting to be read (NO in operation S50), redistribution disks are selected for storing again (second storage) the read-out content data in storage devices (operation S60).

That is, the storage destination selection unit 32 refers to the ID information management table 120 based on the ID of the content data to be stored again and thereby checks the distribution count of the content data. Thus, the storage destination selection unit 32 checks the number of storage devices that need to be mounted (the number of disks that need to be mounted) (operation S70).

The storage destination selection unit 32 then refers to the mounting state management table 130 to check whether the divided data of the content data can be relocated to any of currently mounted storage devices (operation S80).

The storage destination selection unit 32 refers to the mounting state management table 130 to check whether the number of currently mounted storage devices minus the number of storage devices having stored the divided data of the content data to be stored again satisfies the number of disks that need to be mounted.

At this point, the check unit 33 also checks whether the divided data can be stored in storage devices by checking the data size of the divided data and the available space in the storage devices.

If it is determined that any storage devices are capable of relocation (YES in operation S80), the storage destination selection unit 32 selects, as the storage-destination storage devices, those ones among the currently mounted storage devices that have not stored therein the divided data of the content data to be stored again (operation S90).

The mounting control unit 14 mounts the storage devices 20 (target disks) selected as the storage destinations (operation S100). Based on the result of this mounting control by the mounting control unit 14, the table management unit 13 updates the mounting state management table 130 and the readout queue table 140.

Thereafter, the distributed storage control unit 34 locates the reading data in a distributed manner by storing the pieces of divided data respectively in the storage devices selected as the storage destinations (operation S120). Based on the result of this distributed location, the table management unit 13 updates the ID information management table 120.

On the other hand, if it is determined that no storage devices 20 are capable of relocation (NO in operation S80), the storage destination selection unit 32 selects, as the storage destinations, those ones (existing disks) among the currently mounted storage devices that have stored therein the divided data of the content data to be stored again (operation S110). The process then transitions to operation S120.

However, even though the divided data of the same content data is stored again in these storage devices, the storage destination selection unit 32 prevents the same piece of divided data from being stored again in a certain storage device.

That is, the storage destination selection unit 32 interchanges the pieces of divided data to be stored among the selected storage devices, so that the same piece of divided data is not stored in the same storage device before and after the second storage of the content data.

After the distributed location of the reading data, the content management unit 12 checks whether readout of data from the mounted storage devices 20 has been finished (operation S130).

If the readout of data has been finished (YES in operation S130), the mounting control unit 14 puts the storage devices in the unmounted state by instructing the disk driver to separate the storage devices (operation S140), and the process terminates. If the readout of data has not been finished (NO in operation S130), the process simply terminates.

As a result of the check as to whether any other content data is waiting to be read, if such other content data exists (YES in operation S50), the content management unit 12 selects data that allows disk distribution (operation S150).

That is, the storage destination selection unit 32 refers to the readout queue table 140 to check, first for storage devices whose usage state is “mounted,” whether data distribution is possible, i.e., whether the divided data can be stored therein (operation S160).

The storage destination selection unit 32 selects content data whose usage state is “mounted” in the readout queue table 140. The storage destination selection unit 32 then checks whether all storage devices corresponding to storage destinations for divided data of this content data have a sufficient size of available space for storing the divided data.

If a plurality of pieces of content data have the usage state “mounted” in the readout queue table 140, the capability of storing the divided data may be sequentially checked starting from content data to be read out first, for example. Instead of the sequential check starting from the content data to be read out first, content data may also be randomly selected from pieces of content data whose usage state is “mounted” in the readout queue table 140 to check the capability of storing the divided data.

Thus, unauthorized accesses to the divided data of the content data are made difficult, and the security level can be raised.

If the divided data can be stored in storage devices corresponding to content data whose usage state is “mounted” in the readout queue table 140 (YES in operation S160), the storage destination selection unit 32 selects, as the storage destinations for the divided data of the content data to be stored again, the storage devices storing divided data of that content data (operation S170). The process then transitions to operation 5120.

If the divided data cannot be stored in storage devices corresponding to content data whose usage state is “mounted” in the readout queue table 140 (NO in operation S160), the storage destination selection unit 32 refers to the readout queue table 140 to check whether data distribution is possible for storage devices 20 whose usage state is “under mounting” or “waiting to be mounted” (operation S180).

The storage destination selection unit 32 selects content data whose usage state is “under mounting” or “waiting to be mounted” in the readout queue table 140. The storage destination selection unit 32 then checks whether all storage devices 20 corresponding to storage destinations for divided data of this content data have a sufficient size of available space for storing the divided data.

If a plurality of pieces of content data have the usage state “under mounting” or “waiting to be mounted” in the readout queue table 140, the capability of storing the divided data may be sequentially checked starting from content data to be read out first, for example. Instead of the sequential check starting from content data to be read out first, content data may also be randomly selected from pieces of content data whose usage state is “under mounting” or “waiting to be mounted” in the readout queue table 140 to check the capability of storing the divided data.

If the divided data can be stored in storage devices 20 corresponding to content data whose usage state is “under mounting” or “waiting to be mounted” in the readout queue table 140 (YES in operation S180), the storage destination selection unit 32 selects, as the storage destinations for the divided data of the content data to be stored again, the storage devices 20 storing divided data of that content data (operation S190). The process then transitions to operation S120.

On the other hand, if the divided data cannot be stored in storage devices 20 corresponding to content data whose usage state is “under mounting” or “waiting to be mounted” in the readout queue table 140 (NO in operation S180), the process transitions to operation S70.

Thus, first for content data whose usage state is “mounted” among the pieces of content data registered in the readout queue table 140, the storage destination selection unit 32 checks whether the divided data can be stored in corresponding storage devices 20. Therefore, storage devices 20 corresponding to content data in the “mounted” state are preferentially selected. That is, the time for waiting for the completion of the mounting processing by the mounting control unit 14 is reduced, allowing reduction of the processing time for the content redistribution and reduction of load on the mounting control unit 14.

Thus, according to the data management apparatus, data management system, data management method, and data management program as an example of this embodiment, content data is divided into a plurality of pieces of divided data, which are then stored in a plurality of storage devices 20 in a distributed manner. Therefore, for example, even if a malicious manager or third party uses a fraudulently obtained ID or password to access the content management processor 10, the person cannot easily obtain desired content data. This can raise the security level of the content data and increase the reliability.

Also, during the no access state in which a storage device 20 is not accessed, the storage device 20 is kept unmounted. Therefore, a third party or the like cannot easily access the storage device 20, and this can also raise the security level of the content data.

Further, after the completion of the readout processing for the content data, two or more different storage devices 20 to be mounted in the next processing following this readout processing are selected as storage destinations for the divided data. This allows reduction of the time required for storing the divided data. That is, the time for waiting for the completion of the mounting processing by the mounting control unit 14 is reduced, allowing reduction of the processing time for the content redistribution and reduction of load on the mounting control unit 14.

The storage destination selection unit 32 selects, as the storage destinations, storage devices 20 different from storage devices 20 in which the divided data was stored the last time. Therefore, unauthorized accesses by a third party or the like to the divided data are made difficult, and this can also raise the security level of the content data.

Further, for the storage devices 20 selected as the storage destinations by the storage destination selection unit 32, the capability of storing the divided data is checked before storing the divided data in the storage devices 20. Therefore, the processing of storing the divided data can be efficiently performed to allow reduction of the time required for storing the divided data in the storage devices 20.

The disclosed data management apparatus, data management system, data management method, and data management program are not limited to the above-described embodiments but may be implemented with various modifications without departing from the spirit of these embodiments.

Regardless of the above-described embodiment, the exemplary embodiments may be implemented with various modifications without departing from the spirit of the embodiment.

With the above-described embodiment disclosed, those skilled in the art may implement and manufacture the data management apparatus, data management system, data management method, and data management program of the exemplary embodiments.

The embodiments can be implemented in computing hardware (computing apparatus) and/or software, such as (in a non-limiting example) any computer that can store, retrieve, process and/or output data and/or communicate with other computers. The results produced can be displayed on a display of the computing hardware. A program/software implementing the embodiments may be recorded on computer-readable media comprising computer-readable recording media. The program/software implementing the embodiments may also be transmitted over transmission communication media. Examples of the computer-readable recording media include a magnetic recording apparatus, an optical disk, a magneto-optical disk, and/or a semiconductor memory (for example, RAM, ROM, etc.). Examples of the magnetic recording apparatus include a hard disk device (HDD), a flexible disk (FD), and a magnetic tape (130). Examples of the optical disk include a DVD (Digital Versatile Disc), a DVD-RAM, a CD-ROM (Compact Disc-Read Only Memory), and a CD-R (Recordable)/RW. An example of communication media includes a carrier-wave signal.

All examples and conditional language recited herein are intended for pedagogical purposes to aid the reader in understanding the principles of the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiment(s) of the present invention(s) has(have) been described in detail, it should be understood that the various changes, substitutions, and alterations could be made hereto without departing from the spirit and scope of the invention Further, according to an aspect of the embodiments, any combinations of the described features, functions and/or operations can be provided.

The many features and advantages of the embodiments are apparent from the detailed specification and, thus, it is intended by the appended claims to cover all such features and advantages of the embodiments that fall within the true spirit and scope thereof. Further, since numerous modifications and changes will readily occur to those skilled in the art, it is not desired to limit the inventive embodiments to the exact construction and operation illustrated and described, and accordingly all suitable modifications and equivalents may be resorted to, falling within the scope thereof.

1. A data management apparatus performing storage processing and readout processing of data for a plurality of storage devices, comprising:
a division unit that divides the data into two or more pieces of divided data;
a storage destination selection unit that selects, as storage destinations for the pieces of divided data, two or more different storage devices mounted on the data management apparatus; and
a distributed storage control unit that stores the pieces of divided data divided by the division unit in the storage destinations selected by the storage destination selection unit in a distributed manner.

2. The data management apparatus according to claim 1, wherein
after completion of the readout processing of the data, the storage destination selection unit selects, as the storage destinations, two or more different storage devices mounted on the data management apparatus in the readout processing.

3. The data management apparatus according to claim 1, wherein
after completion of the readout processing of the data, the storage destination selection unit selects, as the storage destinations, two or more different storage devices to be mounted on the data management apparatus in processing following the readout processing.

4. The data management apparatus according to claim 1, wherein
the storage destination selection unit selects, as the storage destinations, storage devices different from storage devices in which the pieces of divided data were stored last time.

5. The data management apparatus according to claim 1, further comprising
a check unit that checks whether the storage devices are capable of storing the pieces of divided data, wherein
the distributed storage control unit stores the pieces of divided data in the storage devices confirmed by the check unit as being capable of storing the pieces of divided data.

6. The data management apparatus according to claim 1, further comprising
an unmounting control unit that keeps a storage device unmounted from the data management apparatus during a no access state in which the storage device is not accessed.

7. A data management system including a plurality of storage devices capable of storing data and a data management apparatus performing storage processing and readout processing of the data for the plurality of storage devices, comprising:
a division unit that divides the data into two or more pieces of divided data;
a storage destination selection unit that selects, as storage destinations for the pieces of divided data, two or more different storage devices mounted on the data management apparatus; and
a distributed storage control unit that stores the pieces of divided data divided by the division unit in the storage destinations selected by the storage destination selection unit in a distributed manner.

8. The data management system according to claim 7, wherein
after completion of the readout processing of the data, the storage destination selection unit selects, as the storage destinations, two or more different storage devices mounted on the data management apparatus in the readout processing.

9. The data management system according to claim 7, wherein
after completion of the readout processing of the data, the storage destination selection unit selects, as the storage destinations, two or more different storage devices to be mounted on the data management apparatus in processing following the readout processing.

10. The data management system according to claim 7, wherein
the storage destination selection unit selects, as the storage destinations, storage devices different from storage devices in which the pieces of divided data were stored last time.

11. The data management system according to claim 7, further comprising
a check unit that checks whether the storage devices are capable of storing the pieces of divided data, wherein
the distributed storage control unit stores the pieces of divided data in the storage devices confirmed by the check unit as being capable of storing the pieces of divided data.

12. The data management system according to claim 7, further comprising
an unmounting control unit that keeps a storage device unmounted from the data management apparatus during a no access state in which the storage device is not accessed.

13. A data management method in a data management apparatus performing storage processing and readout processing of data for a plurality of storage devices, comprising:
a division operation of dividing the data into two or more pieces of divided data;
a storage destination selection operation of selecting, as storage destinations for the pieces of divided data, two or more different storage devices mounted on the data management apparatus; and
a distributed storage control operation of storing the pieces of divided data divided in the division operation in the storage destinations selected in the storage destination selection operation in a distributed manner.

14. The data management method according to claim 13, wherein
after completion of the readout processing of the data, two or more different storage devices mounted on the data management apparatus in the readout processing are selected as the storage destinations.

15. The data management method according to claim 13, wherein
after completion of the readout processing of the data, two or more different storage devices to be mounted on the data management apparatus in processing following the readout processing are selected as the storage destinations.

16. The data management method according to claim 13, wherein
storage devices different from storage devices in which the pieces of divided data were stored last time are selected as the storage destinations.

17. The data management method according to claim 13, further comprising
a check operation of checking whether the storage devices are capable of storing the pieces of divided data, wherein
the pieces of divided data are stored in the storage devices confirmed in the check operation as being capable of storing the pieces of divided data.

18. The data management method according to claim 13, further comprising
an unmounting control operation of keeping a storage device unmounted from the data management apparatus during a no access state in which the storage device is not accessed.

19. A management apparatus, comprising:
a microprocessor capable of separating data;
a selection unit capable of selecting a plurality of storage devices mounted on the management apparatus for storage of the separated data; and
a controller outputting the selection.
